(19) United States
(12) Patent Application Publication
(10) Pub. No.: US 2026/0112554 A1
(43) Pub. Date: Apr. 23, 2026

(54) DUAL-TOGGLE SWITCH MODULE AND LIGHTING DEVICE HAVING THE SAME

(71) Applicant: Xiamen PVTECH Co., Ltd., Xiamen (CN)

(72) Inventors: Yanling Xiao, Xiamen (CN); LIANGLIANG CAO, Xiamen (CN); FUXING LU, Xiamen (CN); Dejia Li, Xiamen (CN)

(73) Assignee: Xiamen PVTECH Co., Ltd., Xiamen (CN)

(21) Appl. No.: 19/239,927

(22) Filed: Jun. 16, 2025

(30) Foreign Application Priority Data
Oct. 23, 2024 (CN) 202422567643.6

(51) Int. Cl. H01H 15/10; F21V 23/04

(52) U.S. Cl. CPC H01H 15/10; F21V 23/04

(57) ABSTRACT

The present invention provides a dual-toggle switch module and a lighting device having the same. The dual-toggle switch module includes a first switch, a second switch and a housing. The first switch includes a first terminal and a first handle disposed on and embedded into the first terminal. The second switch includes a second terminal and a second handle disposed on and embedded into the second terminal. The housing includes an opening. The first terminal and the second terminal are disposed within the housing, and the first handle and the second handle are exposed through the opening.

### BACKGROUND OF THE INVENTION

### 1. Field of the Invention

The present invention relates to a switch module, in particular to a dual-toggle switch module. The present invention further relates to the lighting device having the dual-toggle switch module.

### 2. Description of the Prior Art

Generally, currently available DIP switch modules are equipped with only a single switch, thus offering limited configuration options and significantly restricting the functionality thereof. Thus, the currently available DIP switch modules fail to meet actual requirements.

To achieve multiple configuration options, users need to install multiple DIP switch modules on the device. These DIP switch modules occupy more space and reduce the available space for other components on the device. As a result, the currently available DIP switch modules are highly inconvenient to use.

Furthermore, installing multiple DIP switch modules on a single device also significantly increases the overall cost of the device. Therefore, the application of the currently available DIP switch modules is greatly limited.

### SUMMARY OF THE INVENTION

One embodiment of the present invention provides a dual-toggle switch module, which includes a first switch, a second switch and a housing. The first switch includes a first terminal and a first handle disposed on and embedded into the first terminal. The second switch includes a second terminal and a second handle disposed on and embedded into the second terminal. The housing includes an opening. The first terminal and the second terminal are disposed within the housing, and the first handle and the second handle are exposed through the opening.

Another embodiment of the present invention provides a lighting device, which includes a controller and a dual-toggle switch module. The dual-toggle switch module includes a first switch, a second switch and a housing. The first switch includes a first terminal and a first handle disposed on and embedded into the first terminal. The second switch includes a second terminal and a second handle disposed on and embedded into the second terminal. The housing includes an opening. The first terminal and the second terminal are disposed within the housing, and the first handle and the second handle are exposed through the opening.

The dual-toggle switch module and the lighting device having the same in accordance with the embodiments of the present invention may have the following advantages:
(1) In one embodiment of the present invention, the dual-toggle switch module includes a first switch, a second switch and a housing. The first switch includes a first terminal and a first handle disposed on and embedded into the first terminal. The second switch includes a second terminal and a second handle disposed on and embedded into the second terminal. The housing includes an opening. The first terminal and the second terminal are disposed within the housing, and the first handle and the second handle are exposed through the opening. Via the aforementioned structural design, the dual-toggle switch module can have two side-by-side switches, which cany provide more configuration options and enabling additional functionalities. As a result, the dual-toggle switch module can satisfy actual requirements.
(2) In one embodiment of the present invention, the first switch of the dual-toggle switch module includes a first terminal, and the second switch of the dual-toggle switch module includes a second terminal. One side of the first terminal has a first positioning portion, and one side of the second terminal has a second positioning portion. The first positioning portion presses against the second terminal, and the second positioning portion presses against the first terminal. The first positioning portion and the second positioning portion can be alternately arranged and in contact with each other. The structural design of the first positioning portion and the second positioning portion can make sure that the movement directions of the first terminal and the second terminal are fixed. In this way, the structural stability of the dual-toggle switch module can be significantly improved so as to enhance the reliability of the dual-toggle switch module.
(3) In one embodiment of the present invention, the dual-toggle switch module can have two side-by-side switches, thereby achieving the desired functionalities with fewer dual-toggle switch modules and avoiding excessive space occupation. Therefore, the dual-toggle switch module is more convenient to use and can save costs. As a result, the dual-toggle switch module can meet the needs of different users.
(4) In one embodiment of the present invention, the dual-toggle switch module can have two side-by-side switches, thereby providing more configuration options. Therefore, the dual-toggle switch module can be applied to various applications such as parameter settings and network group settings. Accordingly, the dual-toggle switch module can be more flexible in use.
(5) In one embodiment of the present invention, the design of the dual-toggle switch module is simple, so the dual-toggle switch module can achieve the desired effects while reducing costs. Therefore, the practicality of the dual-toggle switch module can be significantly improved. In this way, the dual-toggle switch module can meet the needs of different intelligent applications in order to align with future development trends.

Further scope of applicability of the present application will become more apparent from the detailed description given hereinafter. However, it should be understood that the detailed description and specific examples, while indicating exemplary embodiments of the present invention, are given by way of illustration only, since various changes and modifications within the spirit and scope of the present invention will become apparent to those skilled in the art from this detailed description.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is an exploded view of a dual-toggle switch module in accordance with a first embodiment of the present invention.

FIG. 2 is a first perspective view of the dual-toggle switch module in accordance with the first embodiment of the present invention.

FIG. 3 is a second perspective view of the dual-toggle switch module in accordance with the first embodiment of the present invention.

FIG. 4 is a first schematic view of an end cap having the dual-toggle switch module in accordance with a second embodiment of the present invention.

FIG. 5 is a second schematic view of the end cap having the dual-toggle switch module in accordance with the second embodiment of the present invention.

FIG. 6 is a third schematic view of the end cap having the dual-toggle switch module in accordance with the second embodiment of the present invention.

FIG. 7 is an exploded view of a dual-toggle switch module in accordance with a third embodiment of the present invention.

FIG. 8 is a first schematic view of combining a light tube having the with another light tube in accordance with the third embodiment of the present invention.

FIG. 9 is a partial enlargement view of an area K1 of FIG. 8.

FIG. 10 is a second schematic view of combining the light tube having the dual-toggle switch module with another light tube in accordance with the third embodiment of the present invention.

FIG. 11 is a perspective view of a lighting device having a dual-toggle switch module in accordance with the fourth embodiment of the present invention.

FIG. 12 is a perspective view of a lighting device having a dual-toggle switch module in accordance with the fifth embodiment of the present invention.

FIG. 13 is a perspective view of a lighting device having a dual-toggle switch module in accordance with the sixth embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

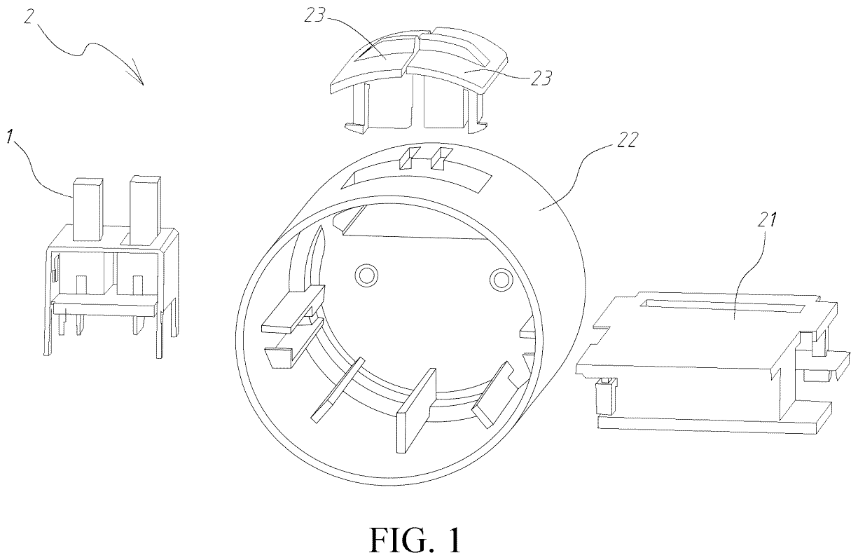

Please refer to FIG. 1, which is an exploded view of a dual-toggle switch module in accordance with a first embodiment of the present invention. As shown in FIG. 1, the end cap 2 includes a dual-toggle switch module 1, an electronic module 21, an outer casing 22, and two switch covers 23. The dual-toggle switch module 1 can be a DIP switch, single-pole double-throw (SPDT) switch, double-pole double-throw (DPDT) switch, or other similar components. The dual-toggle switch module 1 can be implemented based on SMD, DIP plug, or other similar technologies.

The dual-toggle switch module 1 and the electronic module 21 can be disposed within the outer casing 22. The dual-toggle switch module 1 is exposed from the upper opening of the outer casing 22, and the two switch covers 23 are disposed on the dual-toggle switch module 1. The dual-toggle switch module 1 can also be installed on other devices (such as lighting devices, sentry devices, alarms, or other different devices) and is not limited to the end cap 2.

The embodiment just exemplifies the present invention and is not intended to limit the scope of the present invention; any equivalent modification and variation according to the spirit of the present invention is to be also included within the scope of the following claims and their equivalents.

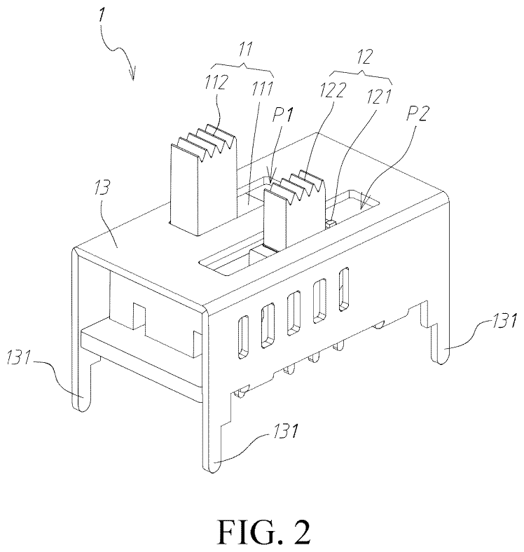

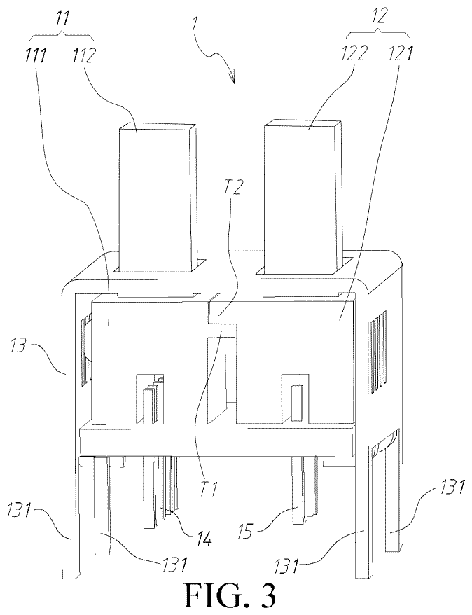

Please refer to FIG. 2 and FIG. 3. FIG. 2 is a first perspective view of the dual-toggle switch module in accordance with the first embodiment of the present invention. FIG. 3 is a second perspective view of the dual-toggle switch module in accordance with the first embodiment of the present invention.

As shown in FIG. 2 and FIG. 3, the dual-toggle switch module 1 includes a first switch 11, a second switch 12, a housing 13, a plurality of first pins 14, and a plurality of second pins 15.

The first switch 11 includes a first terminal 111 and a first handle 112. The first handle 112 is disposed on and embedded into the first terminal 111. The top of the first handle 112 may have a wave-like structure and can be made of plastic. In another embodiment, the first handle 112 may also be made of other materials (such as metal).

The second switch 12 includes a second terminal 121 and a second handle 122. The second handle 122 is disposed on and embedded into the second terminal 121. The top of the second handle 122 may have a wave-like structure and can be made of plastic. In another embodiment, the second handle 122 may also be made of other materials (such as metal). As described above, this embodiment is a dual-switch structure formed by embedding a small DIP switch into a large DIP switch.

The housing 13 includes an opening. The first terminal 111 and the second terminal 121 are disposed within the housing 13. The first handle 112 and the second handle 122 are both exposed from this opening. In this embodiment, the opening includes a first opening P1 and a second opening P2. The first handle 112 is exposed from the first opening P1, and the second handle 122 is exposed from the second opening P2. The second opening P2 may be larger than, equal to, or smaller than the first opening P1. In this embodiment, the second opening P2 is larger than the first opening P1. In another embodiment, the first opening P1 may be larger than the second opening P2. In yet another embodiment, the first opening P1 may be equal to the second opening P2. One side of the first terminal 111 has a first positioning portion T1, and one side of the second terminal 121 has a second positioning portion T2. The first positioning portion T1 presses against the second terminal 121, and the second positioning portion T2 presses against the first terminal 111. The bottom plate of the housing 13 has a plurality of extending portions 131. The structure of the aforementioned opening can be modified according to actual requirements, and the present invention is not limited to this.

The first pins 14 pass through the bottom plate of the housing 13 and are electrically connected to the first terminal 111.

The second pins 15 pass through the bottom plate of the housing 13 and are electrically connected to the second terminal 121.

As described above, one side of the first terminal 111 has a first positioning portion T1, and one side of the second terminal 121 has a second positioning portion T2. The first positioning portion T1 presses against the second terminal 121, and the second positioning portion T2 presses against the first terminal 111. In this embodiment, the first positioning portion T1 and the second positioning portion T2 are elongated protrusions. The first positioning portion T1 and the second positioning portion T2 are alternately arranged and in contact with each other. In this way, the structural design of the first positioning portion T1 and the second positioning portion T2 can make sure that the movement directions of the first terminal 111 and the second terminal 121 are fixed. Thus, the structural stability of the dual-toggle switch module 1 can be significantly improved, enhancing the reliability of the dual-toggle switch module 1.

Via the aforementioned structural design, the dual-toggle switch module 1 can have two side-by-side switches, thereby providing more configuration options and enabling additional functionalities. Therefore, the dual-toggle switch module 1 can conform to actual requirements.

In addition, the dual-toggle switch module 1 can have two side-by-side switches, thereby achieving the desired functionalities with fewer dual-toggle switch modules 1 and avoiding excessive space occupation. Therefore, the dual-toggle switch module 1 is more convenient to use and can save costs. Thus, the dual-toggle switch module 1 can meet the needs of different users. Furthermore, the dual-toggle switch module 1 can provide more configuration options. Therefore, the dual-toggle switch module 1 can be applied to various applications such as parameter settings and network group settings, such that dual-toggle switch module 1 can be more flexible in use.

The embodiment just exemplifies the present invention and is not intended to limit the scope of the present invention; any equivalent modification and variation according to the spirit of the present invention is to be also included within the scope of the following claims and their equivalents.

It is worthy to point out that the currently available DIP switch modules are equipped with only a single switch, thus offering limited configuration options and significantly restricting the functionality thereof. Thus, the currently available DIP switch modules fail to meet actual requirements. To achieve multiple configuration options, users need to install multiple DIP switch modules on the device. These DIP switch modules occupy more space and reduce the available space for other components on the device. As a result, the currently available DIP switch modules are highly inconvenient to use. Furthermore, installing multiple DIP switch modules on a single device also significantly increases the overall cost of the device. Therefore, the application of the currently available DIP switch modules is greatly limited. By contrast, according to one embodiment of the present invention, the dual-toggle switch module includes a first switch, a second switch and a housing. The first switch includes a first terminal and a first handle disposed on and embedded into the first terminal. The second switch includes a second terminal and a second handle disposed on and embedded into the second terminal. The housing includes an opening. The first terminal and the second terminal are disposed within the housing, and the first handle and the second handle are exposed through the opening. Via the aforementioned structural design, the dual-toggle switch module can have two side-by-side switches, which cany provide more configuration options and enabling additional functionalities. As a result, the dual-toggle switch module can satisfy actual requirements.

Also, according to one embodiment of the present invention, the first switch of the dual-toggle switch module includes a first terminal, and the second switch of the dual-toggle switch module includes a second terminal. One side of the first terminal has a first positioning portion, and one side of the second terminal has a second positioning portion. The first positioning portion presses against the second terminal, and the second positioning portion presses against the first terminal. The first positioning portion and the second positioning portion can be alternately arranged and in contact with each other. The structural design of the first positioning portion and the second positioning portion can make sure that the movement directions of the first terminal and the second terminal are fixed. In this way, the structural stability of the dual-toggle switch module can be significantly improved so as to enhance the reliability of the dual-toggle switch module.

Further, according to one embodiment of the present invention, the dual-toggle switch module can have two side-by-side switches, thereby achieving the desired functionalities with fewer dual-toggle switch modules and avoiding excessive space occupation. Therefore, the dual-toggle switch module is more convenient to use and can save costs. As a result, the dual-toggle switch module can meet the needs of different users.

Moreover, according to one embodiment of the present invention, the dual-toggle switch module can have two side-by-side switches, thereby providing more configuration options. Therefore, the dual-toggle switch module can be applied to various applications such as parameter settings and network group settings. Accordingly, the dual-toggle switch module can be more flexible in use.

Furthermore, according to one embodiment of the present invention, the design of the dual-toggle switch module is simple, so the dual-toggle switch module can achieve the desired effects while reducing costs. Therefore, the practicality of the dual-toggle switch module can be significantly improved. In this way, the dual-toggle switch module can meet the needs of different intelligent applications in order to align with future development trends. As set forth above, the dual-toggle switch module according to the embodiments of the present invention can indeed achieve great technical effects.

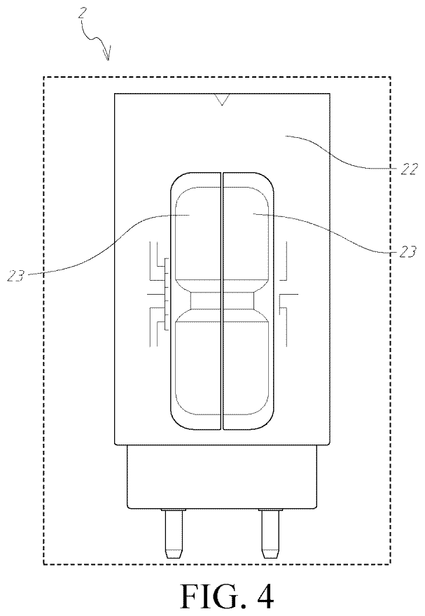

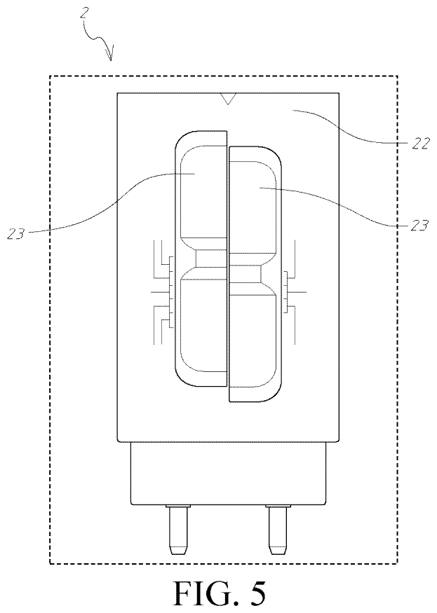

Please refer to FIG. 4 and FIG. 5. FIG. 4 is a first schematic view of an end cap having the dual-toggle switch module in accordance with a second embodiment of the present invention. FIG. 5 is a second schematic view of the end cap having the dual-toggle switch module in accordance with the second embodiment of the present invention. Please also refer to FIG. 1, FIG. 2, and FIG. 3. As shown in FIG. 4, the end cap 2 can achieve 15 (3*5) level selections through the dual-toggle switch module 1 to generate a level selection signal. The dual-toggle switch module 1 is connected to the controller (not shown in FIG. 4) of the end cap 2. The controller can generate a control signal according to the level selection signal to perform various operations (e.g., parameter setting, networking group setting, color temperature level switching, and brightness level switching, etc.).

The embodiment just exemplifies the present invention and is not intended to limit the scope of the present invention; any equivalent modification and variation according to the spirit of the present invention is to be also included within the scope of the following claims and their equivalents.

As shown in FIG. 5, one switch cover 23 is disposed on the first handle 112 of the dual-toggle switch module 1, and the other switch cover 23 is disposed on the second handle 122 of the dual-toggle switch module 1. The user can toggle the two switch covers 23 to control the first switch 11 and the second switch 12, thereby achieving level selection. In this way, the user can perform various operations such as parameter settings and network group settings.

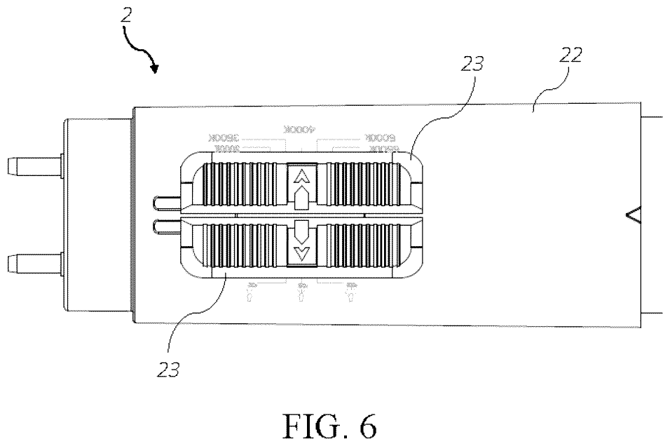

Please refer to FIG. 6, which is a third schematic view of the end cap having the dual-toggle switch module in accordance with the second embodiment of the present invention. Please also refer to FIG. 1, FIG. 2, FIG. 3, FIG. 4, and FIG. 5. As shown in FIG. 6, the end cap 2 can achieve multiple color temperature level switches and multiple brightness level switches through the dual-toggle switch module 1.

The embodiment just exemplifies the present invention and is not intended to limit the scope of the present invention; any equivalent modification and variation according to the spirit of the present invention is to be also included within the scope of the following claims and their equivalents.

As previously stated, the dual-toggle switch module 1 can have two side-by-side switches, thereby providing more configuration options and enabling additional functionalities. Therefore, the dual-toggle switch module 1 can meet actual requirements. Since the dual-toggle switch module 1 can have two side-by-side switches, the dual-toggle switch module 1 can achieve the desired functionalities with fewer dual-toggle switch modules 1, avoiding excessive space occupation. Thus, the dual-toggle switch module 1 is more convenient to use and can save costs. Therefore, the dual-toggle switch module 1 can meet the needs of different users. Furthermore, since the dual-toggle switch module 1 can have two side-by-side switches, the dual-toggle switch module 1 can provide more configuration options. Therefore, the dual-toggle switch module 1 can be applied to various applications such as parameter settings and network group settings, so the dual-toggle switch module 1 can be more flexible in use. Additionally, the design of the dual-toggle switch module 1 is simple, such that the dual-toggle switch module 1 can achieve the desired effects while reducing costs. Thus, the practicality of the dual-toggle switch module 1 can be significantly improved, and the dual-toggle switch module 1 can meet the needs of different smart applications so as to align with future development trends.

The embodiment just exemplifies the present invention and is not intended to limit the scope of the present invention; any equivalent modification and variation according to the spirit of the present invention is to be also included within the scope of the following claims and their equivalents.

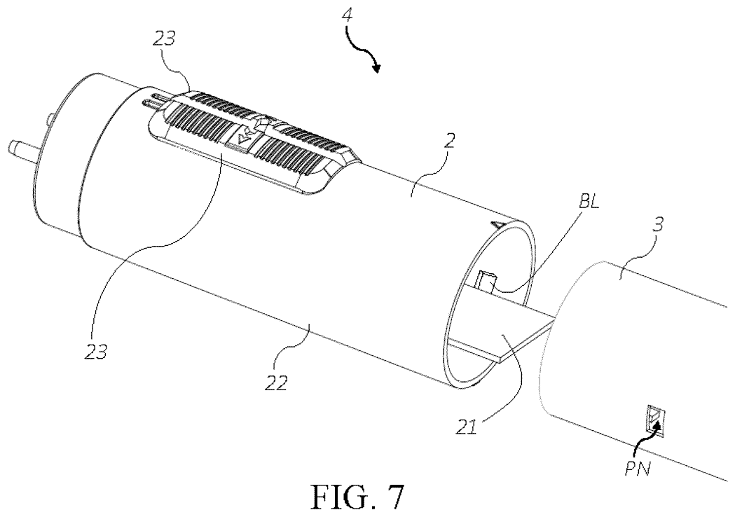

Please refer to FIG. 7, which is an exploded view of a dual-toggle switch module in accordance with a third embodiment of the present invention. The end cap of this light tube has a dual-toggle switch module. As shown in FIG. 7, the light tube 4 includes an end cap 2 and a tube body 3, and the end cap 2 has a dual-toggle switch module 1. The inner wall of the end cap 2 may have two locking blocks BL, which are disposed opposite to each other. One end of the tube body 3 has two holes PN, which are also disposed opposite to each other. The two locking blocks BL are corresponding to the two holes PN. Therefore, when the end cap 2 and the tube body 3 are assembled, the two locking blocks BL can be embedded into the two holes PN, fixing the end cap 2 and the tube body 3 together. In this way, the end cap 2 can be fixed to one end of the tube body 3. The number of locking blocks BL and holes PN can be modified according to actual requirements. The tube body 3 can be made of plastic or glass, or the tube body 3 can be a nanotube made of a mixture of plastic (PC) and glass fiber.

The embodiment just exemplifies the present invention and is not intended to limit the scope of the present invention; any equivalent modification and variation according to the spirit of the present invention is to be also included within the scope of the following claims and their equivalents.

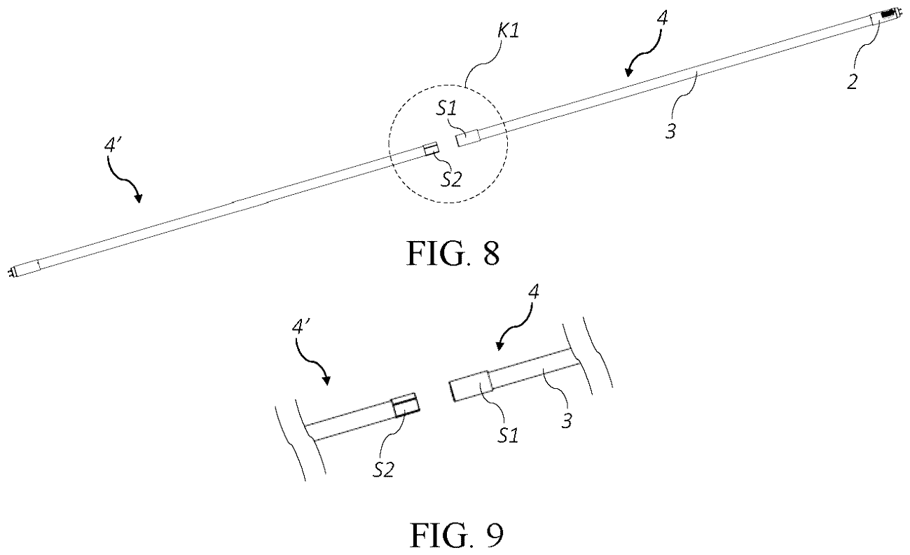

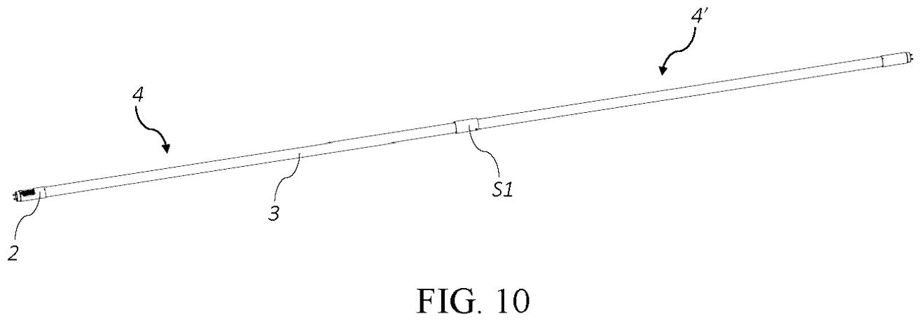

Please refer to FIG. 8, FIG. 9, and FIG. 10. FIG. 8 is a first schematic view of combining a light tube having the dual-toggle switch module with another light tube in accordance with the third embodiment of the present invention. FIG. 9 is a partial enlargement view of an area K1 of FIG. 8. FIG. 10 is a second schematic view of combining the light tube having the dual-toggle switch module with another light tube in accordance with the third embodiment of the present invention. The end cap of the light tube has the dual-toggle switch module. As shown in FIG. 8, the light tube 4 further includes a large sleeve CT1, which can be fixed to the other end of the tube body 3. One end of another light tube 4′ may have a small sleeve CT2.

As shown in FIG. 9, the light tube 4 and another light tube 4′ can be combined through the large sleeve CT1 and the small sleeve CT2.

As shown in FIG. 10, the combination of the light tube 4 and another light tube 4′ can form a long light tube to meet the needs of different applications.

The embodiment just exemplifies the present invention and is not intended to limit the scope of the present invention; any equivalent modification and variation according to the spirit of the present invention is to be also included within the scope of the following claims and their equivalents.

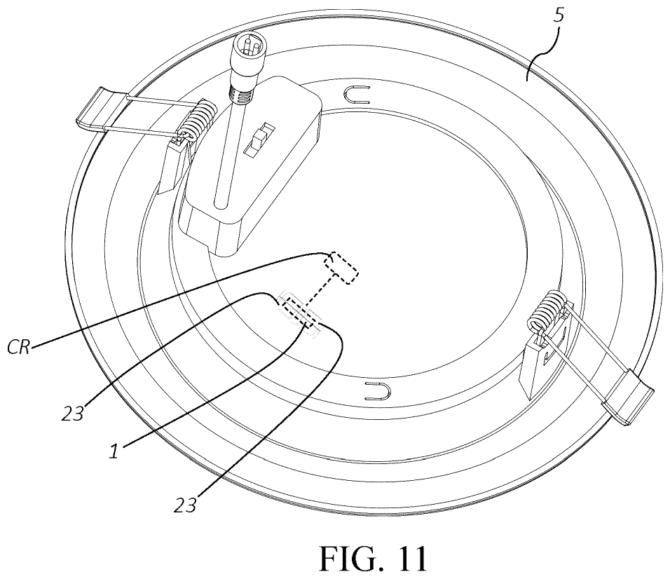

Please refer to FIG. 11, which is a perspective view of a lighting device having a dual-toggle switch module in accordance with the fourth embodiment of the present invention. As shown in FIG. 11, the lighting device 5 is a downlight, and includes a controller CR and a dual-toggle switch module 1. The controller CR is connected to the dual-toggle switch module 1. Meanwhile, the lighting device 5 has two switch covers 23 disposed on the dual-toggle switch module 1.

The user can operate the dual-toggle switch module 1 to generate a level selection signal. The controller can generate a control signal according to the level selection signal to perform various operations (e.g., parameter setting, networking group setting, color temperature level switching, and brightness level switching, etc.). In one embodiment, the controller may be a microcontroller (MCU). In another embodiment, the controller may be a central-processing unit (CPU), application-specific integrated circuit (ASIC), field-programmable gate array (FPGA), or other similar components.

The embodiment just exemplifies the present invention and is not intended to limit the scope of the present invention; any equivalent modification and variation according to the spirit of the present invention is to be also included within the scope of the following claims and their equivalents.

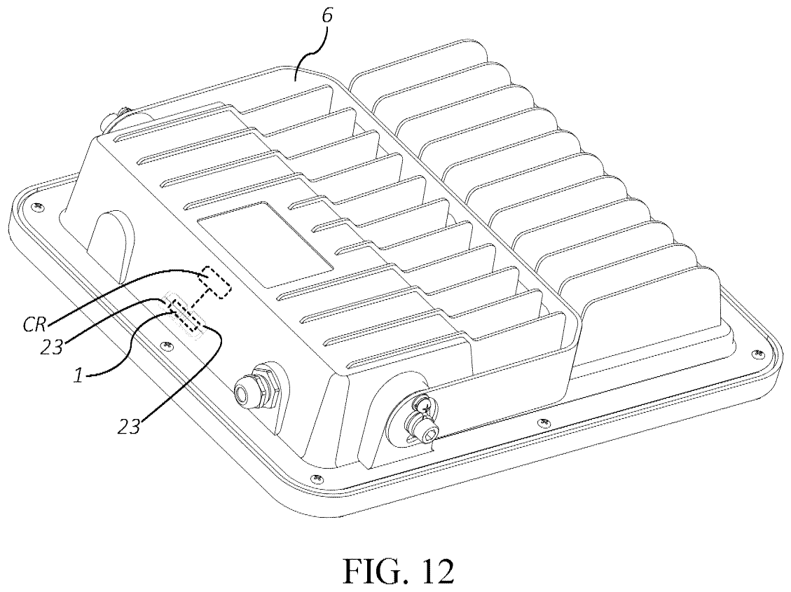

Please refer to FIG. 12, which is a perspective view of a lighting device having a dual-toggle switch module in accordance with the fifth embodiment of the present invention. As shown in FIG. 12, the lighting device 6 is a floodlight, and includes a controller CR and a dual-toggle switch module 1. The controller CR is connected to the dual-toggle switch module 1. Meanwhile, the lighting device 6 has two switch covers 23 disposed on the dual-toggle switch module 1.

Similarly, the user can operate the dual-toggle switch module 1 to generate a level selection signal. The controller can generate a control signal according to the level selection signal to perform various operations (e.g., parameter setting, networking group setting, color temperature level switching, and brightness level switching, etc.).

The embodiment just exemplifies the present invention and is not intended to limit the scope of the present invention; any equivalent modification and variation according to the spirit of the present invention is to be also included within the scope of the following claims and their equivalents.

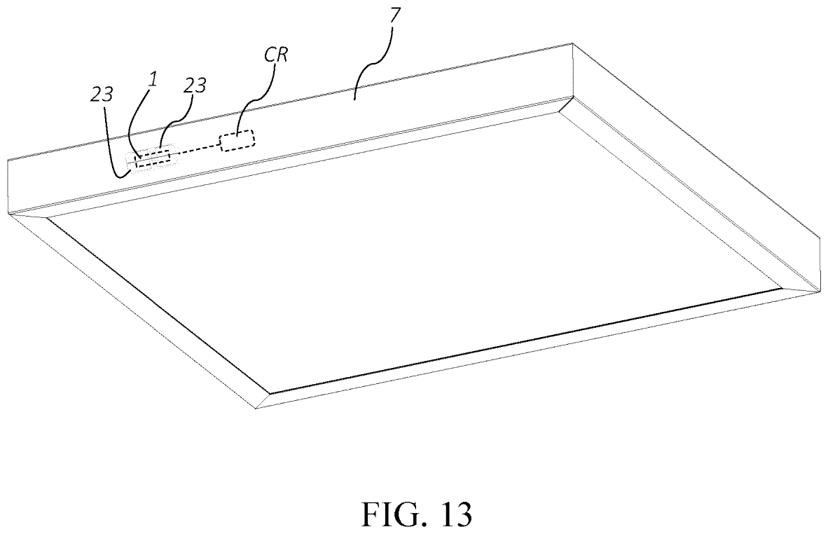

Please refer to FIG. 13, which is a perspective view of a lighting device having a dual-toggle switch module in accordance with the fifth embodiment of the present invention. As shown in FIG. 13, the lighting device 7 is a panel light, and includes a controller CR and a dual-toggle switch module 1. The controller CR is connected to the dual-toggle switch module 1. Meanwhile, the lighting device 7 has two switch covers 23 disposed on the dual-toggle switch module 1.

Similarly, the user can operate the dual-toggle switch module 1 to generate a level selection signal. The controller can generate a control signal according to the level selection signal to perform various operations (e.g., parameter setting, networking group setting, color temperature level switching, and brightness level switching, etc.).

As set forth above, in addition to tube lights, the dual-toggle switch module 1 can be applied to various lighting devices (including but not limited to downlights, floodlights, and panel lights), so the dual-toggle switch module 1 can be more flexible in use.

The embodiment just exemplifies the present invention and is not intended to limit the scope of the present invention; any equivalent modification and variation according to the spirit of the present invention is to be also included within the scope of the following claims and their equivalents.

To sum up, according to one embodiment of the present invention, the dual-toggle switch module includes a first switch, a second switch and a housing. The first switch includes a first terminal and a first handle disposed on and embedded into the first terminal. The second switch includes a second terminal and a second handle disposed on and embedded into the second terminal. The housing includes an opening. The first terminal and the second terminal are disposed within the housing, and the first handle and the second handle are exposed through the opening. Via the aforementioned structural design, the dual-toggle switch module can have two side-by-side switches, which cany provide more configuration options and enabling additional functionalities. As a result, the dual-toggle switch module can satisfy actual requirements.

Also, according to one embodiment of the present invention, the first switch of the dual-toggle switch module includes a first terminal, and the second switch of the dual-toggle switch module includes a second terminal. One side of the first terminal has a first positioning portion, and one side of the second terminal has a second positioning portion. The first positioning portion presses against the second terminal, and the second positioning portion presses against the first terminal. The first positioning portion and the second positioning portion can be alternately arranged and in contact with each other. The structural design of the first positioning portion and the second positioning portion can make sure that the movement directions of the first terminal and the second terminal are fixed. In this way, the structural stability of the dual-toggle switch module can be significantly improved so as to enhance the reliability of the dual-toggle switch module.

Further, according to one embodiment of the present invention, the dual-toggle switch module can have two side-by-side switches, thereby achieving the desired functionalities with fewer dual-toggle switch modules and avoiding excessive space occupation. Therefore, the dual-toggle switch module is more convenient to use and can save costs. As a result, the dual-toggle switch module can meet the needs of different users.

Moreover, according to one embodiment of the present invention, the dual-toggle switch module can have two side-by-side switches, thereby providing more configuration options. Therefore, the dual-toggle switch module can be applied to various applications such as parameter settings and network group settings. Accordingly, the dual-toggle switch module can be more flexible in use.

Furthermore, according to one embodiment of the present invention, the design of the dual-toggle switch module is simple, so the dual-toggle switch module can achieve the desired effects while reducing costs. Therefore, the practicality of the dual-toggle switch module can be significantly improved. In this way, the dual-toggle switch module can meet the needs of different intelligent applications in order to align with future development trends.

It will be apparent to those skilled in the art that various modifications and variations can be made to the disclosed embodiments. It is intended that the specification and examples be considered as exemplary only, with a true scope of the present invention being indicated by the following claims and their equivalents.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A dual-toggle switch module, comprising:
a first switch comprising a first terminal and a first handle disposed on and embedded into the first terminal;
a second switch comprising a second terminal and a second handle disposed on and embedded into the second terminal; and
a housing comprising an opening, wherein the first terminal and the second terminal are disposed within the housing, and the first handle and the second handle are exposed through the opening.

2. The dual-toggle switch module as claimed in claim 1, wherein the opening comprises a first opening and a second opening, wherein the first handle is exposed from the first opening, and the second handle is exposed from the second opening.

3. The dual-toggle switch module as claimed in claim 2, wherein the second opening is greater than or equal to the first opening.

4. The dual-toggle switch module as claimed in claim 1, wherein one side of the first terminal has a first positioning portion, and one side of the second terminal has a second positioning portion, wherein the first positioning portion presses against the second terminal, and the second positioning portion presses against the first terminal.

5. The dual-toggle switch module as claimed in claim 4, wherein the first positioning portion and the second positioning portion are alternately arranged.

6. The dual-toggle switch module as claimed in claim 5, wherein the first positioning portion and the second positioning portion are in contact with each other.

7. The dual-toggle switch module as claimed in claim 1, wherein the first positioning portion and the second positioning portion are elongated protrusions.

8. The dual-toggle switch module as claimed in claim 1, wherein the first handle and the second handle are made of plastic.

9. The dual-toggle switch module as claimed in claim 1, further comprising a plurality of first pins and a plurality of second pins, wherein the first pins pass through a bottom plate of the housing and are electrically connected to the first terminal, and the second pins pass through the bottom plate of the housing and are electrically connected to the second terminal.

10. The dual-toggle switch module as claimed in claim 1, wherein a bottom plate of the housing has a plurality of extending portions.

11. A lighting device, comprising:
a controller;
a dual-toggle switch module connected to the controller, and comprises a first switch, a second switch and a housing, wherein the first switch comprises a first terminal and a first handle disposed on and embedded into the first terminal, and the second switch comprises a second terminal and a second handle disposed on and embedded into the second terminal; and the housing comprises an opening, wherein the first terminal and the second terminal are disposed within the housing, and the first handle and the second handle are exposed through the opening.

12. The lighting device as claimed in claim 11, wherein the opening comprises a first opening and a second opening, wherein the first handle is exposed from the first opening, and the second handle is exposed from the second opening.

13. The lighting device as claimed in claim 12, wherein the second opening is greater than or equal to the first opening.

14. The lighting device as claimed in claim 11, wherein one side of the first terminal has a first positioning portion, and one side of the second terminal has a second positioning portion, wherein the first positioning portion presses against the second terminal, and the second positioning portion presses against the first terminal.

15. The lighting device as claimed in claim 14, wherein the first positioning portion and the second positioning portion are alternately arranged.

16. The lighting device as claimed in claim 15, wherein the first positioning portion and the second positioning portion are in contact with each other.

17. The lighting device as claimed in claim 11, wherein the first positioning portion and the second positioning portion are elongated protrusions.

18. The lighting device as claimed in claim 11, wherein the first handle and the second handle are made of plastic.

19. The lighting device as claimed in claim 11, further comprising a plurality of first pins and a plurality of second pins, wherein the first pins pass through a bottom plate of the housing and are electrically connected to the first terminal, and the second pins pass through the bottom plate of the housing and are electrically connected to the second terminal.

20. The lighting device as claimed in claim 11, wherein a bottom plate of the housing has a plurality of extending portions.
